(19) United States
(12) Patent Application Publication
(10) Pub. No.: US 2002/0154131 A1
(43) Pub. Date: Oct. 24, 2002

(54) System status display control module

(76) Inventor: Andy Cheu, Taipei Hsien (TW)

Correspondence Address: BACON & THOMAS, PLLC, 625 Slaters Lane, 4th Floor, Alexandria, VA, 22314-1176, US

(21) Appl. No.: 09/837,470

(22) Filed: Apr. 19, 2001

(51) Int. Cl. G09G 5/00

(52) U.S. Cl. 345/581

(57) ABSTRACT

This invention is a System Status Display Control Module, for the main purpose of detecting whether the CPU voltage is stable, the current is normal, or the temperature is lower than specified setting, the hard disk voltage and temperature, and whether the revolutions of radiating fan is lower than specified setting, the conditions are immediately displayed and controlled; including a Status Detector to detect he aforementioned components and transmit the information to a Control Logic; a Control Logic that compares the data obtained from the status detector with the data in the Standard Data Storage Device, which are then respectively provided to the CPU/Power Supply and Display unit for control and display; a Standard Data Storage Device that stores the specification data of the aforementioned components; and a Display unit that displays the information after it is compared and verified by the Control Logic, so that the system's conditions can be immediately displayed and controlled.

### BACKGROUND OF THE INVENTION

1. Field of the Invention

This invention relates to a “System Status Display Control Module”, which is fitted to a personal computer, comprising a Status Detector, a Control Logic, a Standard Data Storage Device and a Display unit, for the purpose of detecting and displaying the conditions of various components inside the computer, including the CPU, for better control of the computer performance.

2. Background of the Invention

The development of CPU's in the personal computer has progressed from 3 μM twenty years ago to 0.18 μM at the present. Its calculating speed has been increased from 4.77 MHz in an IBM PC/XT model to 1.5 GHz at the present. Though its calculating operation is expedited, the power consumption of CPU has increased accordingly. As a result, the CPU produce higher and higher heat, which means the CPU cooling system has to play a more important role, or else such delicate and sophisticated CPU could be burned and destroyed.

Nowadays, the computer operating system and hard disk have involved a power management device for the CPU. The radiating fan and radiator have also included some sort of radiating treatment for the CPU. However, the ordinary user has no ready understanding of the working conditions of the CPU (including the operating voltage, power consumption and temperature of the CPU). In case the cooling fan slows down (or stops completely) and the user has no way of knowing the irregularity, the CPU or the computer system could be burned within seconds.

Furthermore, the number of modern CPU's logic gates has exceeded 10 millions, its working frequency has reached as high as 1.5 GHz, and power consumption in the excess of 60W. All knows it that the CPU is the heart of a computer, which requires constant monitoring and maintenance. The number of DIY computers has been occupying a high percentage. Such computer's CPU and cooling system are assembled by individual users or computer shops. The highly sophisticated CPU produces higher heat. In case the other components could not have consistent specifications to coordinate perfectly with the sophisticated CPU, or in case of the user's negligence (such as opening and executing too many software programs) or extended use, the computer system or the CPU performance could be jeopardized. Any abnormality without being detected in time could damage or burn the CPU.

Furthermore, the capacity of hard disk has been increased drastically, its operating speed is becoming quicker and quicker, the speed of CD-ROM is also increased significantly, the display interface has become more sophisticated, the memory capacity has been expanded, the data transmission speed is doubled in a DDR-SDRAM, such highly sophisticated computer components require stability and radiation to enable normal performance.

### BRIEF DESCRIPTION OF THE INVENTION

The main objective of this invention is to provide a “System Status Display Control Module” that will monitor the working conditions and protect the safety of the CPU, that can even be expanded to monitor any devices and accessories (such as the memory or the hard disk) that any designer considers worth monitoring.

The secondary objective of this invention is to provide a “System Status Display Control Module” with the function of monitoring and displaying the immediate working conditions of the CPU, to enable the user, the assembler or computer shopkeeper to gain understanding of any problems.

### BRIEF DESCRIPTION OF DRAWINGS

The drawings of preferred embodiment of this invention are described in following details to enable better understanding.

FIG. 1 is a block diagram of the invention.

### BRIEF DESCRIPTION OF NUMERALS

10 Status Detectors and D/A converter

20 Control Logic

30 Standard Data Storage Device

40 Display

50 CPU/Power Supply

### DETAILED DESCRIPTION OF PREFERRED EMBODIMENTS

The abovementioned objectives, structures and functional characteristics of the invention are described in details in the following preferred embodiment.

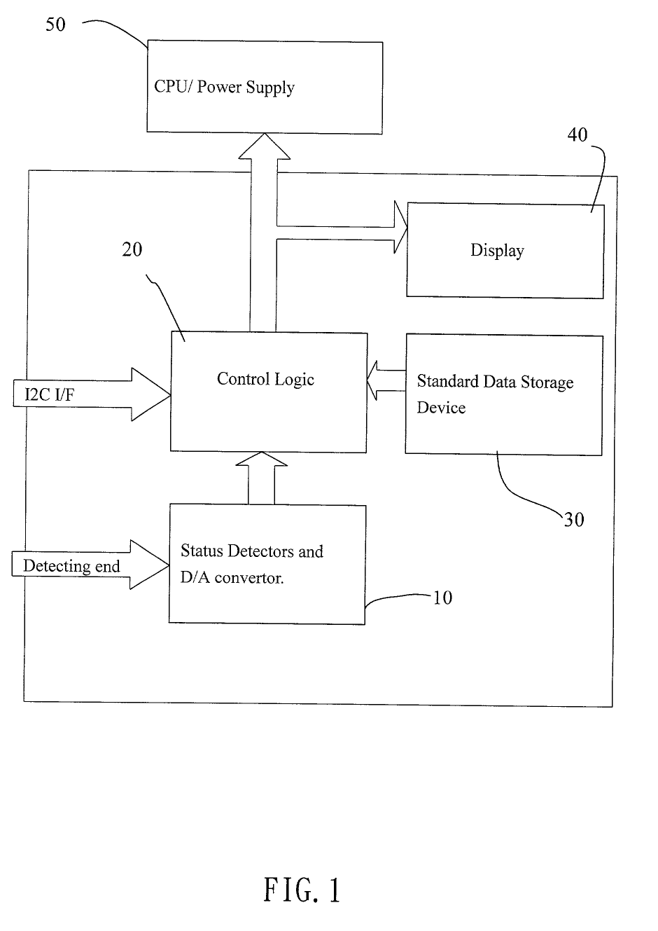

This invention provides a control module for the display of system status. As shown in FIG. 1, the module is installed on the computer, comprising a Status Detectors and D/A converter 10, a Control Logic 20, a Standard Data Storage Device 30, Display 40 and a CPU/Power Supply 50.

The module takes the conditions of the instantaneous voltage, current, temperature and fan revolution of the CPU, and the readings of all components in the computer, such as the temperature of the hard disk, which are compared with the standard specifications of all components in the computer, then they are displayed, for proper control of the CPU and the power supply.

(1) The Status Detector 10 detects whether the voltage is stable, the current is normal, the temperature is consistent with specified range, or the fan revolutions are excessively low. Then, the data obtained by the detector are converted by the Analog/Digital Converter into digital format or directly transmitted through the I2C interface (the interface between IC's) to the Control Logic 20.

The above detection:

1. The voltage-detecting device is responsible for detection of CPU voltage, including the input voltage VCC_IO of I/O Logic, and the input voltage VCC_CORE of CPU Core.

2. The current-detecting device is responsible for detection of CPU current, including the input current at the I/O Logic terminal, and the input current at the CPU Core Logic terminal.

3. The temperature detector detects the temperature of the CPU, hard disk, etc. The fan revolution detector detects the revolutions of all cooling fans, such as CPU fan, hard disk fan, casing fan (at front and rear), or the power supply fan, even including the CD-ROM fan, and

4. The revolution detector employs an optical theory. When the fan blades pass the ray of an optical detector, they obstruct the light projection. The optical detector receives low-potential input and converts it into logic. The potential variation frequency is divided by the number of fan blades, and then the time measuring unit is added in.

(2) The Control Logic Device 20 compares the various data coming from the Status Detector 10 with those stored in the Standard Data Storage Device, and then the signals are displayed through the Display 40, and the fan revolutions are changed or the CPU/Power Supply 50 is controlled to suit the circumstances, to interrupt the CPU operation or switch off power.

(3) The Standard Data Storage Device 30 is an Electronically Erasable Programmable Read Only Memory, EEPROM applicable to the storage of computer data: including specifications of the CPU, fan, etc.

The above specifications:

1. CPU specifications, including CPU working temperature range, the input voltage and current specifications of CPU I/O logic terminal, and the input voltage and current specifications of CPU Core logic terminal.

2. Fan specifications, including fan input voltage and revolution specifications.

The data storage of the Standard Data Storage Device 30 is accomplished through the 12C interface.

(4) The Display 40 displays the data coming from the Control Logic 20. The Display 40 includes various display units, such as calorimetric LED, 7-step LED or LCD.

(5) The CPU/Power Supply 50 refers to the CPU or Power Supply under control. When the control logic is verified and found to be abnormal (for example: when the revolutions of CPU cooling fan is found to be too low, or the CPU temperature is found too high, etc.), such a signal will be displayed on the Display 40 to be monitored by the user. At the same time, the revolutions of the fan will be changed, or operation of the CPU will be interrupted, or the power will be switched off, so that the user will be able to know what goes wrong and make necessary repair before the computer has suffered any damage or is burned. In the process of assembling Do-It-Yourself computer, the user will be able to detect abnormality and replace with proper components in time. Even after the assembly is completed, the user can detect abnormal conditions before the computer is damaged or burned, and make necessary maintenance.

Besides the use of 12C as the control interface between the system inside the computer and the subject invention of module, the control interface for the Control Logic 20 can be ISA Bus, PCI Bus, USB, Serial Port, or Parallel Port.

To conclude, this invention provides a system status display control module, which is capable of monitoring CPU's working conditions and maintain CPU safety, thereby it is equipped with the functions of monitoring and displaying the real-time working conditions of the CPU, enabling the computer user, assembler or shopkeeper to locate where the trouble is. Having the above novelty and inventive step, which are consistent with the requirements for a patent right, this application is duly filed. Your favorable consideration will be appreciated.

The above description covers merely the preferred embodiment of this invention. All variations of methods, shapes, construction, etc. deriving from the above description shall be included in the subject claim.

What is claimed is:

1. A system status display control module, for the purpose of detecting the working conditions of the computer, such as voltage, current, and temperature of the CPU, the voltage and temperature of the hard disk, revolutions of radiating fan, and such components inside the computer, which are instantly displayed and controlled; comprising:
a Status Detector, for detecting the conditions of the aforementioned components, which are transmitted to a Control Logic;
a Control Logic, for comparing the data detected by the Status Detector with the data inside the Standard Data Storage Device, which are respectively provided to the “CPU/Power Supply” and the “Display” for respective control and display;
a Standard Data Storage Device, for storing various specifications and data of the aforementioned components; and
a Display unit, for displaying the information after it is verified by the Control Logic.

2. The System Status Display and Control Module as claimed in claim 1, wherein, the Control Logic serves to control the CPU to interrupt operation, or switch off the computer through the power supply, or change the revolutions of the fan.

3. The System Status Display and Control Module as claimed in claim 1 or 2, wherein, the Standard Data Storage Device is an Electronically Erasable and Programmable ROM.

4. The System Status Display and Control Module as claimed in claim 1 or 2, wherein, the Standard Data Storage Device accomplish data storage performance through an I2C interface.

5. The System Status Display and Control Module as claimed in claim 1 or 2, wherein; the Display unit can be a color-separating LED, 7-step LED or LED.

6. The System Status Display and Control Module as claimed in claim 1 or 2, wherein, the Control Logic includes I2C as the control interface between the computer interior system and this module, the control interface may be ISA Bus, PCI Bus, USB, Serial Port or Parallel Port.
